(19) United States
(12) Patent Application Publication
(10) Pub. No.: US 2006/0116115 A1
(43) Pub. Date: Jun. 1, 2006

(54) Automatic call conversion system, apparatus and method based on location information

(75) Inventor: Myung-kyu Lee, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/281,354

(22) Filed: Nov. 18, 2005

(30) Foreign Application Priority Data
Dec. 1, 2004 (KR) 2004-99695

(51) Int. Cl. H04M 3/42

(52) U.S. Cl. 455/417; 455/445

(57) ABSTRACT

Disclosed is an automatic call conversion system based on location information, including: a sensor network for tracing a location of a telephone user in real time mode, and transmitting corresponding location information; a plurality of telephone terminals, each being implemented with a call forwarding function, for the telephone user; and an automatic call conversion apparatus for receiving the location information of the telephone user from the sensor network, selecting among the plurality of telephone terminals a telephone terminal for use in call receiving or call conversion by using the location information, and setting a speech path with the selected terminal or converting a call to the selected terminal. In this manner, call forwarding or call connection can be done more effectively.

### CROSS-REFERENCE TO RELATED APPLICATIONS

This application claims priority from Korean Patent Application No. 2004-99695 filed on Dec. 1, 2004 under 35 U.S.C. § 119, the entire content of which is incorporated herein by reference.

### BACKGROUND OF THE INVENTION

1. Field of the Invention:

Apparatuses and methods consistent with the present invention relate in general to an automatic call conversion system, an apparatus and a method, more specifically, to an automatic call conversion system, an apparatus and a method based on a user's location information.

2. Description of the Related Art

Ever since a wired phone was commercialized, almost every home and office has more than one wired phone. But now, rapid technical advances in wireless communication systems have made mobile phones prevail over the wired phones. Mobile phones based on cellular telephone systems, Trunked Radio Systems (TRS) or Personal Communication Service (PCS) systems allow people to roam freely while making and receiving calls from any location, and provide diverse functions.

A well-known feature of a call forwarding function in a telephone exchange system is forwarding calls from one extension to another extension. For instance, a person using a certain extension can receive his (her) call at another extension in a different location, given that two extensions use the same telephone exchange system.

In conventional call forwarding, a service subscriber inputs a forwarded extension code in a memory of a forwarding extension to redirect a call, so that when the forwarded extension code is inputted, that is, when the forwarded line rings, the call is redirected to the forwarded extension where the desired called party (i.e., the subscriber) is situated.

In general, a cellular mobile communication system provides call forwarding and absence transfer services unconditionally. Thus, all the service subscribers can do is simply to register or cancel the services.

When a subscriber on the line in an office or a home wants to continue the conversion in a different place, the subscriber had to check and dial the telephone number of the place first and then continue the call in that place. Otherwise, the subscriber had to hang up the phone, move to the place and make another call to continue the conversion he (she) had been engaged in before.

In another situation, suppose that there is an incoming call in an office or a home. If a desired called party is not present (in the office) to receive the call, a phone will just continuously ring, wasting time of a calling party. If this occurs in an office, it will bring inconvenience to other office workers rather than the desired called party.

Also, suppose that the desired called party moves to another place near a different wired phone far from his (her) desk. In this situation, if there is a call for the desired called party, he (she) has to ask someone else to pick up the phone and forward the call to him (her).

### SUMMARY OF THE INVENTION

It is, therefore, an aspect of the present invention to provide an automatic call conversion system, an apparatus and a method for automatically selecting a desired phone terminal and converting a call based on location information of a called party.

It is another aspect of the present invention to provide an automatic call conversion system, an apparatus and a method based on location information of a called party for providing a call intercept service screening incoming calls when a desired called party is absent.

It is still another aspect of the present invention to provide an automatic call conversion system, an apparatus and a method based on location information of a called party for automatically converting (or forwarding) an incoming call to a telephone number where the called party is situated.

To achieve the above aspects and advantages, there is provided an automatic call conversion system, including: a sensor network which traces a location of a telephone user in real time mode, and transmits location information corresponding to the location of the telephone user; a plurality of telephone terminals comprising at least one of wired and wireless telephones, each having a call forwarding function for the telephone user; and an automatic call conversion apparatus which receives the location information of the telephone user from the sensor network, selects among the plurality of telephone terminals a telephone terminal for use in call receiving or call conversion by using the location information, and sets a speech path with the selected terminal or converts a call to the selected telephone terminal.

The sensor network includes: a plurality of sensor nodes which detects the location information of the telephone user in real time mode, and provides the location information to the automatic call conversion apparatus; and a sensor platform which provides the location information from each of the sensor nodes to the automatic call conversion apparatus. The location information of the telephone user may be sensed by a radio frequency tag (RF TAG).

The automatic call conversion apparatus includes: a location detection part which receives and detects the location information of the telephone user provided from the sensor network; and a location detection switch control part which receives the location information from the location detection part, and selects, based on the received location information, the telephone terminal for use in the call receiving or the call conversion for the telephone user.

The automatic call conversion apparatus may further include: a switch part which receives information on the selected telephone terminal from the location detection switch control part, and switches the call to the selected telephone terminal according to the received information. The automatic call conversion apparatus may further include: a central processing unit (CPU) part which performs operations and processes of each functional component in the automatic call conversion apparatus; a memory part which stores data necessary for the automatic call conversion apparatus; a public network interface part which interfaces the automatic call conversion apparatus with a public network; and a tone generation & tone detection & dial pulse detection part which generates a dial tone to be transmitted to a called party or a calling party while dialing, or performs tone detection and dial pulse detection.

The automatic call conversion apparatus may further include an audio processing part which performs audio sensing and audio (or voice) synthesis for sensing information on the called party or location detection exchange mode request information.

Another aspect of the present invention provides an automatic call conversion apparatus which includes: a location detection part which receives and detects location information of a telephone user, the location information of the telephone user being traced in real time mode; and a location detection switch control part which receives the location information of the telephone user from the location detection part, and selecting, based on the received location information, a telephone terminal for use in call connection or call conversion for the telephone user.

The location information of the telephone user may be sensed by an RF TAG.

The apparatus further includes: a switch part which receives information on the selected telephone terminal from the location detection switch control part, and switches the call to the selected telephone terminal according to the received information. The apparatus further includes: a CPU part which performs operations and processes of each functional component in the apparatus; a memory part which stores data necessary for the apparatus; a public network interface part which interfaces the apparatus with a public network; and a tone generation & tone detection & dial pulse detection part for generating a dial tone to be transmitted to a called party or a calling party while dialing, or performs tone detection and dial pulse detection.

The apparatus may further include an audio processing part which performs audio sensing and audio (or voice) synthesis for sensing information on the called party or location detection exchange mode request information.

Another aspect of the present invention provides an automatic call conversion method which includes: a calling party's making a call to a called party and transmitting a call request signal; the calling party's receiving a message requesting to select the called party and inputting information on the called party; based on the inputted information on the called party, detecting a location of the called party; based on the location information of the called party, selecting a telephone terminal for use in call receiving among a plurality of telephone terminals comprising at least one of wired and wireless telephones, each having a call forwarding function for the called party; and setting a speech path between a terminal of the calling party and the selected terminal.

Here, the information on the called party may be inputted through an audio input system or through a dual tone multi-frequency (DTMF) system. Also, the location information of the called party may be sensed by an RF TAG.

The method may further include: if the called party requests a location detection rejection function, transmitting to the calling party a message conveying that the location detection is rejected; and transmitting a ring signal to every telephone terminal available in a network corresponding to the called party.

The method may further include: if the called party requests a location detection rejection function, transmitting to the calling party a message conveying that the location detection is rejected; and connecting a call to a telephone terminal at a pre-designated location of the called party in a network corresponding to the called party.

The method may further include: if the called party is in a situation where receiving the call is not possible, transmitting to the calling party a message conveying that the called party is not able to receive the call; and terminating call connection to the called party.

Here, the situation where the called party is not able to receive the call comprises at least one of a situation where the called party is not found (absent), a situation where the called party requests a location detection rejection function, and a situation where the called party is on another line.

After transmitting to the calling party a message conveying that the called party is not able to receive the call, the method further includes: transmitting to the calling party a message requesting the calling party to record a paging message or a desired message; and the calling party's finishing recording the paging message or the desired message and transmitting the recorded message.

Still another aspect of the present invention provides an automatic call conversion method which includes: a telephone user's making a call to an opposite party or receiving a call from the opposite party with a first telephone terminal through a public network, wherein the telephone user and the first telephone terminal are located in a first area; the telephone user's requesting a location detection exchange mode and converting the first telephone terminal to on-hook; tracing, in real time mode, a location of the telephone user engaged in the call in the first area; if the telephone user moves from the first area to a second area, setting a speech path with a second telephone terminal located in the second area; and if the telephone user picks up a receiver of the second telephone terminal in the second area, resuming the call with the opposite party.

The location detection exchange mode request may be inputted by an audio input system or a DTMF system. Also, after the first telephone terminal is converted to on-hook, the method may further include: transmitting to the opposite party a message conveying that the location detection of the telephone user is in process.

Yet another aspect of the present invention provides an automatic call conversion method which includes: a telephone user's making a call to an opposite party or receiving a call from the opposite party with a first telephone terminal through a public network, wherein the telephone user and the first telephone terminal are located in a first area; the telephone user's requesting a location detection exchange mode and converting the first telephone terminal to on-hook; tracing a location of the telephone user engaged in real time mode; the telephone user's requesting to convert the call to a second telephone terminal located in the first area; and the telephone user's resuming the call to the opposite party with the second telephone terminal.

The location detection exchange mode request may be inputted by an audio input system or a DTMF system. Also, after the first telephone terminal is converted to on-hook, the method further includes transmitting to the opposite party a message conveying that the location detection of the telephone user is in process.

The present invention suggests a system providing an optimum telephone communication environment depending on the location of a telephone user, in consideration of the mobility of the telephone user. That is, the present invention checks the location information of the user in real time mode, and automatically converts a call to a nearest telephone terminal from the current position of the user, regardless of whether the user is currently on the line. Therefore, the inconvenience problems in the limited and fragmentary call forwarding service of the related art can be resolved by providing the full, complete user-centered communication service of the present invention.

To be more specific, although the location of the called party may change, the system of the present invention can detect the location of the called party in real time mode, and automatically convert the call to a telephone terminal in a nearest area where the called party is situated. Therefore, even though the user may move around constantly to do his work or do other personal things, he can receive an incoming call or make an outgoing call anywhere he goes.

Also, when the user currently being on the line wants to move to another location, the system of the present invention automatically converts a call to a nearest telephone terminal from the user. Thus, as in the related art, the user does not have to hang up the phone, check the telephone number of a new location, and make a call again to resume the call from the new location.

To expand and apply the technical concept of the present invention, since the present invention is capable of detecting the location of the called party, if the called party is not able to receive a call for some reason (i.e., the called party is too distant from a forwarded telephone terminal), the call forwarding service is automatically terminated or a message is sent to the calling party, notifying that the called party is not able to receive the call at the moment. In this manner, an optimum and efficient communication environment can be created.

In addition, the system of the present invention can set an automatic call conversion function as optional especially when the called party currently being on the line wants to move to another location. This is mainly because the location information of the called party can easily be exposed to the calling party. Therefore, by allowing the called party to set the location detection rejection function to the system, the forwarded terminal selection function of the present invention can be cancelled. Furthermore, when the location detection rejection function is set to a home network, the present invention can generate a forwarding ring to every telephone terminal available in the corresponding home network. In case of an office network, on the other hand, the present invention connects a call first to a pre-designated telephone of the called party.

### BRIEF DESCRIPTION OF THE DRAWINGS

The above aspects and features of the present invention will become more apparent by describing illustrative, non-limiting embodiments thereof with reference to the accompanying drawings, in which:

FIG. 1 is a conceptual diagram showing an automatic call conversion system based on location information, in accordance with the present invention;

FIG. 2 is a block diagram illustrating an automatic call conversion system based on location information, in accordance with one exemplary embodiment of the present invention;

FIG. 3 illustrates in detail the structure of a location detection switch control part, in accordance with one exemplary embodiment of the present invention;

FIG. 4 is a flow chart for describing an automatic call conversion method based on location information, in accordance with one exemplary embodiment of the present invention;

FIG. 5 is a signal flow graph illustrating a procedure for tracing a called party and selecting a target telephone in ring receive mode, in accordance with a first exemplary embodiment of the present invention;

FIG. 6 is a signal flow graph in ring receive mode of a home network where a called party's privacy protection function is set, in accordance with a first exemplary embodiment of the present invention;

FIG. 7 is a signal flow graph in ring receive mode of an office network where a called party's privacy protection function is set, in accordance with a first exemplary embodiment of the present invention;

FIG. 8 is a signal flow graph in ring receive mode where a called party is absent, in accordance with a first exemplary embodiment of the present invention;

FIG. 9 is a signal flow graph in location detection exchange mode of a situation where a user (i.e., a calling party) currently being on the line moves to another location, in accordance with a second exemplary embodiment of the present invention; and

FIG. 10 is a signal flow graph in location detection exchange mode of a situation where a user (i.e., a calling party) currently being on the line changes a telephone terminal, in accordance with a second exemplary embodiment of the present invention.

### DETAILED DESCRIPTION OF THE EXEMPLARY EMBODIMENTS

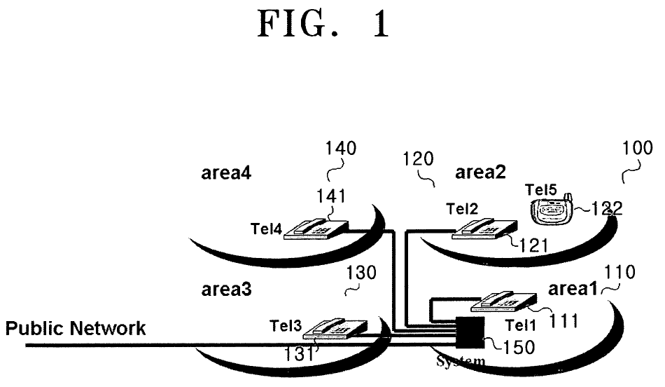

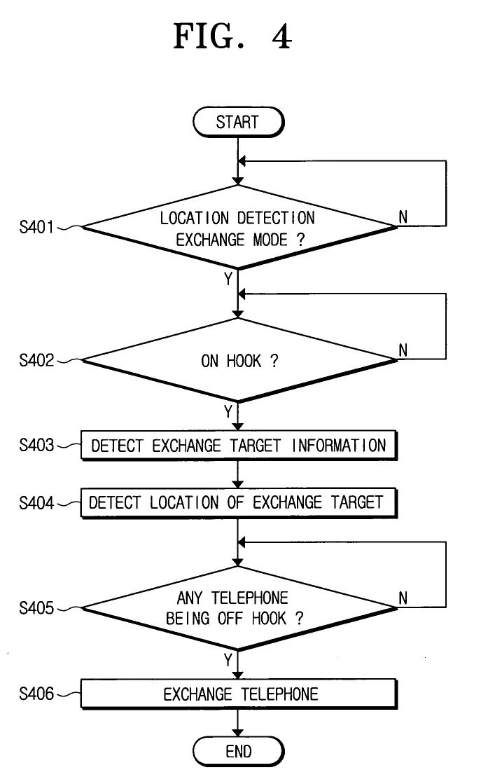

An exemplary embodiment of the present invention will be described herein below with reference to the accompanying drawings. First of all, structures of an automatic call conversion system and an apparatus will be described in reference to FIGS. 1 to 3, and an automatic call conversion method will be described in reference to FIGS. 4 to 10. The embodiment of the present invention will be largely divided into two situations: forwarding a call while the line is engaged, and forwarding an incoming call (i.e., selecting a desired telephone).

FIG. 1 is a conceptual diagram showing an automatic call conversion system based on location information, in accordance with the present invention. Referring to FIG. 1, in a home network 100 composed of a plurality of areas 110, 120, 130 and 140, call conversion based on location information of a called party is automatically performed.

Suppose that a first wired telephone 111 is located in a first area 110, a second wired telephone 121 and a fifth wireless telephone 122 are located in a second area 120, a third wired telephone 131 is located in a third area 130, and a fourth wired telephone 141 is located in a fourth area 140. Then, a called party is able to receive a call with a telephone in an area where the called party is located.

For example, in case of an incoming call, that is, when a calling party makes a call to the called party's home, the call is forwarded to a telephone in a specific area (such as, a bed room or a living room) where the called party is situated. For another example, suppose that a telephone user being currently on the line in the first area 110 wants to move to the fourth area 140. Then, according to the present invention, the call is automatically converted from the first wired telephone to the fourth wired telephone 141.

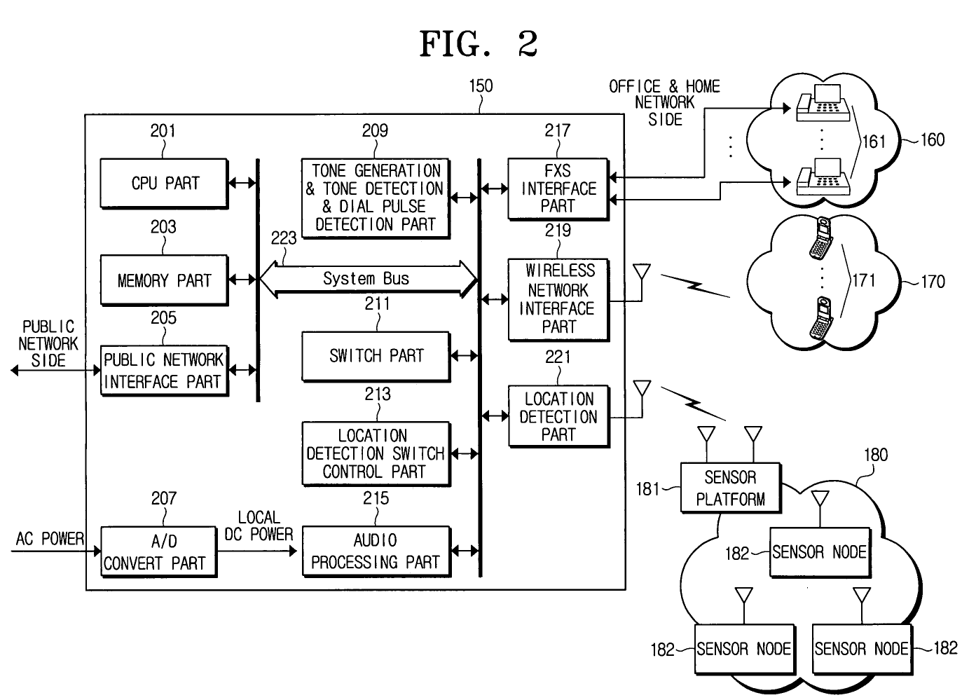

The above-described call forwarding or call conversion function is executed by an automatic call conversion apparatus 150. The automatic call conversion apparatus 150 is located either in the home network system or in a specific external system (e.g., a telephone exchange system). The automatic call conversion apparatus 150 of the present invention checks location information of a called party or a calling party in real time mode, and forwards a call or converts a call to a specific telephone in a corresponding location. More detailed description on the constitution of the automatic call conversion apparatus 150 will be provided in FIG. 2.

Although FIG. 1 illustrates a home network, the present invention is equally applied to other networks such as an office network, allowing an office worker (who can be a calling party or a called party) moves around between networks. For instance, suppose that a called party got off work and went home. While moving from a place to another place, the called party can receive a call using a telephone on his desk while he was at work, his mobile phone while he commutes from work and a wired telephone at home as he arrived at his house.

The following will now explain the automatic call conversion system and apparatus in more detail with reference to FIG. 2.

FIG. 2 illustrates an automatic call conversion system based on location information, according to one embodiment of the present invention. As shown in FIG. 2, the automatic call conversion system includes an automatic call conversion apparatus 150, a general telephone network 160 composed of a plurality of wired telephones 161, a wireless telephone network 170 composed of a plurality of wireless telephones 171, and a sensor network 180 composed of a sensor platform 181 and a plurality of sensor nodes 182.

The sensor network 180 traces a location of a telephone user in real time mode. That is, each sensor node 182 located in a predetermined area checks location information of the telephone user in real time mode, and provides the location information to the automatic call conversion apparatus 150 through the sensor platform 181. Then, based on the location information of the telephone user provided from the sensor network 180, the automatic call conversion apparatus 150 selects a telephone terminal for the telephone user to receive a call and sets a call path (or a speech path) with the corresponding terminal, or selects a telephone terminal for a call conversion.

Therefore, depending on the choice the automatic call conversion apparatus 150 makes, the speech path is set or the call is converted to a specific wired telephone terminal 161 within the general telephone network 160 or to a specific wireless telephone terminal 171 within the wireless telephone network 170.

Referring to FIG. 2, the automatic call conversion apparatus 150 of the invention includes a CPU part 201, a memory part 203, a public network interface part 205, an analog to digital (A/D) converter part 207, a tone generation & tone detection & dial pulse detection part 209, a switch part 211, a location detection switch control part 213, an audio processing part 215, a foreign exchange service (FXS) interface part 217, a wireless network interface part 219, a location detection part 221, and a system bus 223.

Among these components of the automatic call conversion apparatus 150, the location detection switch control part 213 is a new component that is provided for the implementation of the present invention, and the audio processing part 215 or the location detection part 221 is modified from that of a conventional call conversion system to realize the present invention. Depending on the implementation, the rest of components can also be modified or replaced as desired.

As aforementioned, the location information of the telephone user (hereinafter, it will be referred to simply as “user”) from the sensor network 180 is provided to and checked by the location detection part 221 of the automatic call conversion apparatus 150. In other words, the location detection part 221 checks the location information including information of the user and the user's wired or wireless telephones. This can be done in various ways. A preferable method is using a radio frequency tag (hereinafter, it will be referred to as “RF TAG”) that is an intrinsic tag given to an object (i.e., a telephone) or a person. By applying a location sensing method using a location sensor of the RF TAG, a location of the user can be sensed accurately by several centimeters (cm).

Once the location detection part 221 checks the location information of the user and the wired or wireless telephones, the information is then transmitted to the location detection switch control part 213. Based on the received location information, the location detection switch control part 213 decides to which telephone terminal it should convert or forward the call.

Information on the telephone selection result made by the location detection switch control part 213 is provided to the switch part 211, and according to switching of the switch part 211 the call is converted or forwarded to a corresponding telephone. At this time, if the corresponding telephone is a wired terminal, the call is connected to a corresponding wired telephone terminal 161 of the wired telephone network 160 through the FXS interface part 217. On the other hand, if the corresponding telephone is a wireless terminal, the call is connected to a corresponding wireless telephone terminal 171 of the wireless telephone network 170 through the wireless network interface part 219. Here, an example of the wireless telephone terminal 171 includes 900 MHz band cordless telephones that are widely used in homes.

The CPU part 201 is in charge of operations and processes of each functional component in the automatic call conversion apparatus 150. The memory part 203 stores data necessary for the automatic call conversion apparatus 150. Also, the public network interface part 205 interfaces the automatic call conversion apparatus 150 with a public network, and the tone generation & tone detection & dial pulse detection part 209 generates a dial tone to be transmitted to a called party or a calling party while dialing, or performs tone detection and dial pulse detection.

The audio processing part 215 is in charge of audio sensing and audio (or voice) synthesis for sensing the information of the called party or the location detection exchange mode request information (to be described). The A/D convert part 207 provides a direct current (DC) voltage in need of the operation of each component in the automatic call conversion apparatus 150. The system bus 223 functions as a data channel between components in the automatic call conversion apparatus 150.

The sensor platform 181 of the sensor network 180 transmits information of each sensor node 182 to the automatic call conversion apparatus 150, and each sensor node 182 also transmits its location information being detected to the automatic call conversion apparatus 150.

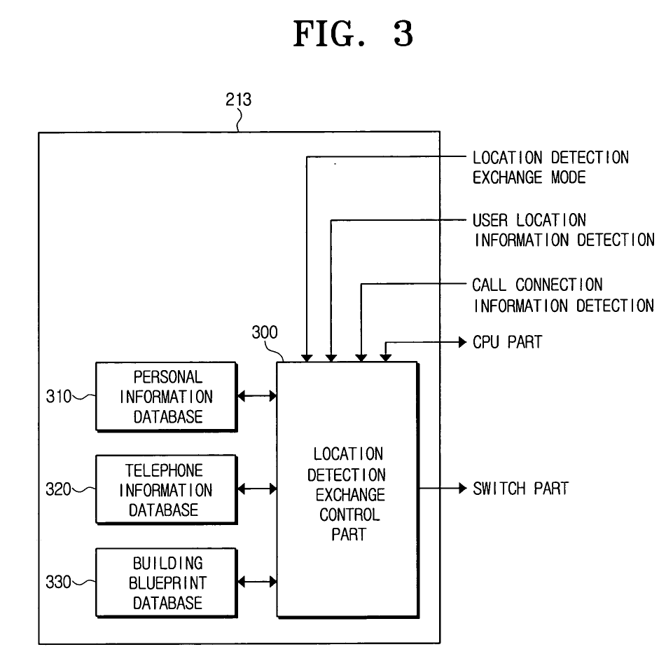

With reference to FIG. 3, the following will now explain in detail a specific component of the automatic call conversion apparatus 150 according to one exemplary embodiment of the present invention.

FIG. 3 illustrates in detail a structure of the location detection switch control part 213 according to one exemplary embodiment of the present invention. Referring to FIG. 3, the location detection switch control part 213 includes a location detection exchange control part 300, a personal information database 310, a telephone information database 320, and a building blueprint database 330.

The personal information database 310 stores information of users (that is, service subscribers) of the automatic call conversion service. Examples of the user information include names of the users, RF TAG information, etc. The telephone information database 320 stores information of telephones for use in the automatic call conversion service. Examples of the telephone information include RF TAG information of each telephone. The building blueprint database 330 stores structural information of a building (e.g., a home or an office). Examples of the structural information of a building include locations of walls within the building, coordinates, etc.

The location detection exchange control part 300 receives location detection exchange information of a user or a called party using a corresponding telephone being sensed, location information of the user and call connection information, and based on the information stored in the personal information database 310, the telephone information database 320 and the building blueprint database 330, respectively, it selects a final destination telephone or a call conversion target telephone and transmits the selection result to the switch part 211.

In other words, on the basis of the pre-stored structural information of a building and information on the location of a telephone and the current location of the user, the location detection switch control part 213 forwards or converts a call to a telephone in a nearest area from the user.

The following will now explain an automatic call conversion method according to one embodiment of the present invention.

FIG. 4 is a flow chart explaining an automatic call conversion procedure based on location information, according to the present invention. As described in FIG. 4, first it is checked whether a called party is in location detection exchange mode (S401). When the location detection exchange mode is set, it is checked whether a telephone of the called party is on-hook (S402). If the telephone is on-hook, it means that the called party is able to answer the phone. Thus, the automatic call conversion apparatus of the present invention checks information of a location detection exchange target (S403), and detects a location of the exchange target as described above (S404).

In case there is a telephone around the called party, the corresponding telephone rings. Then, the called party picks up the receiver of the corresponding telephone and the corresponding telephone is converted to off-hook (S405). In this manner, call conversion to the corresponding telephone is completed (S406).

That is to say, when a call is made to the user who set the location detection exchange mode, the present invention based on the location information of the user allows the user to receive the call through a (geographically) nearest telephone from him.

As aforementioned, the telephone terminal selection or the call conversion based on the location information of a called party or a user can be performed in two different modes: ring receive mode (that is, in case of an incoming call from a calling party) and location detection exchange mode (that is, when the user on the line moves to another place).

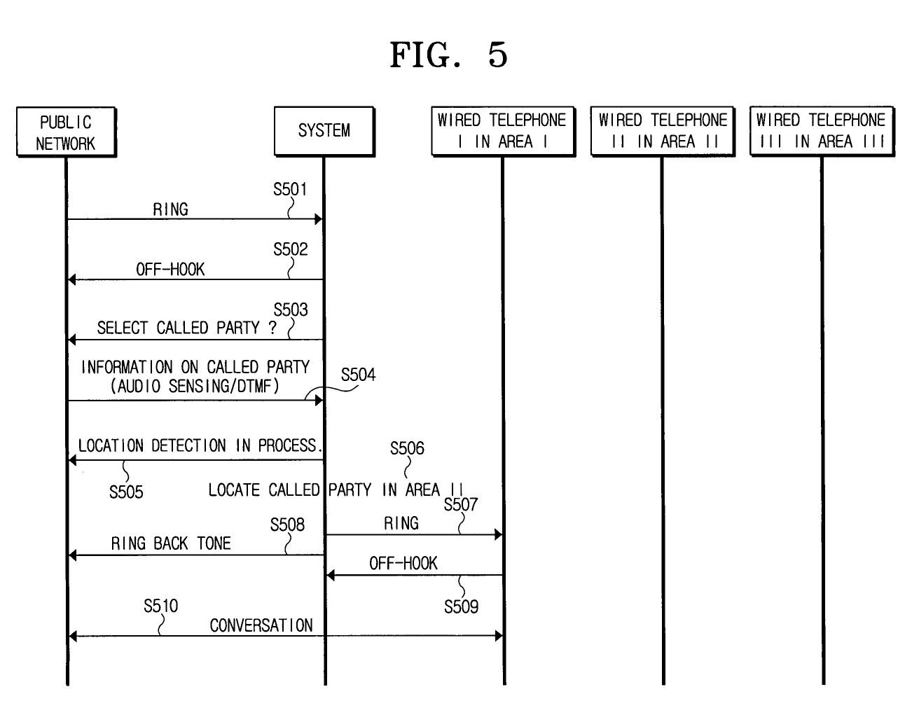

First of all, a signal flow procedure in the ring receive mode will be explained referring to FIGS. 5 to 8.

### Embodiment 1

Ring Receive Mode

This exemplary embodiment concerns a situation where an incoming call is made by a calling party. Depending on a situation that may arise, the embodiment can be categorized into three types: a situation where general location exchange mode is set, a situation where location detection is denied by a home network or an office network, and a situation where a called party is absent.

FIG. 5 signal flow graph illustrates a procedure for tracing a called party and selecting a target telephone in the ring receive mode. Referring to FIG. 5, when a calling party makes a phone call to a called party, a call request signal is transmitted from a public network to the system of the present invention (S501). If the system is off hook (S502), a message is sent to the calling party to select a called party (S503). Here, the system means the automatic call conversion system of the present invention, more specifically, the automatic call conversion apparatus that receives location information of the called party from the sensor network, selects a target telephone terminal, and switches a call thereto.

Upon receiving the message, the calling party inputs information about the desired called party by selecting buttons based on an audio or a DTMF system (S504). After receiving the information from the calling party, the system notifies the calling party of a fact that it is currently detecting a location of the called party (S505), and checks the location of the called party.

If the called party is found in the first area (S506) of FIG. 1, the system transmits a ring signal to the first wired telephone terminal in the first area (S507), and a ring back tone signal to the telephone of the calling party (S508). When the called party in the first area picks up the receiver and the first wired telephone terminal is off-hook (S509), the calling party is able to talk to the called party (S510).

The above-described situation is found in many offices where there is one general directory number and many office workers are provided with extension codes. Therefore, steps S503 and S504 for requesting to select a called party in response to an incoming call from a calling party and inputting the information of the called party are equally applied. However, if the calling party makes a call to one specific person, the steps S503 and S504 are omitted, and the procedure proceeds directly to the location detection step.

If desired, the location detection rejection mode can be set even in the middle of location detection exchange service. In case of a home network, a call request signal may be transmitted simultaneously to every telephone in all of the areas at home. On the other hand, in case of an office network, a call request signal may be transmitted to a telephone terminal at a designated location, regardless of a current location of a called party.

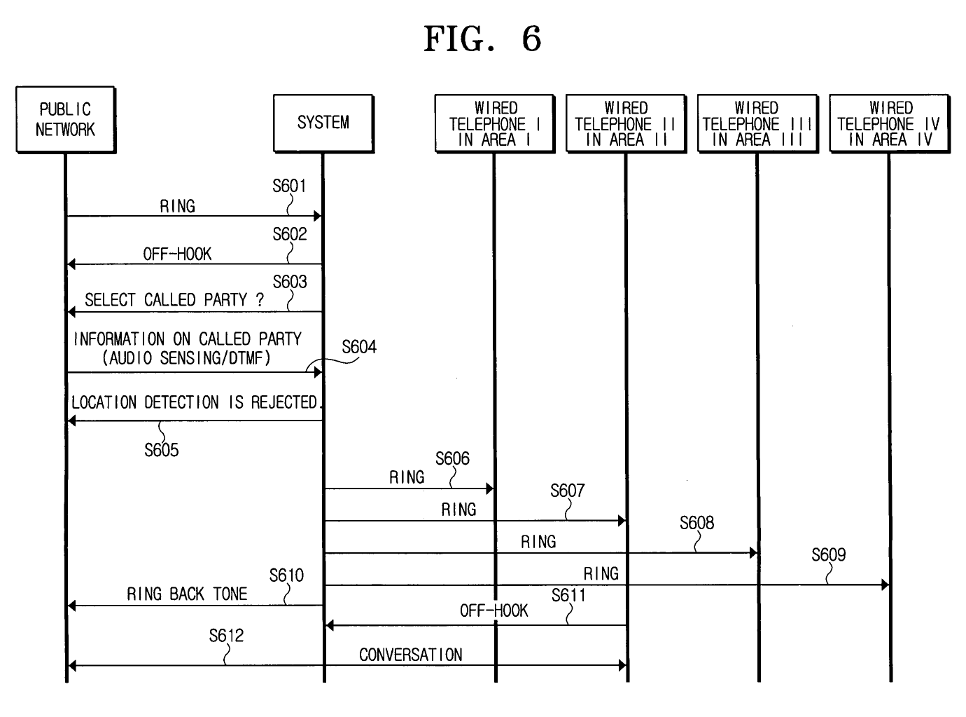

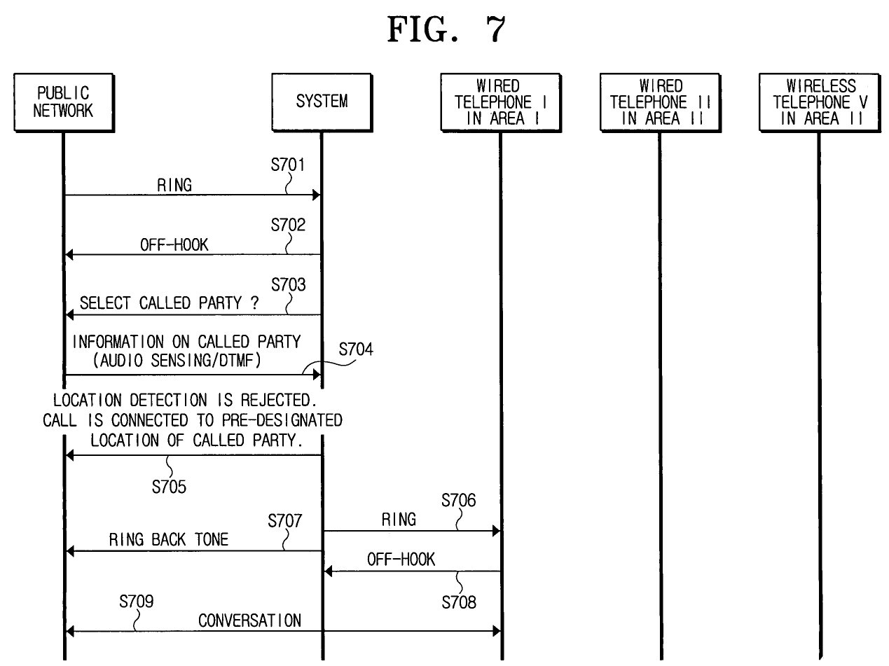

Among those situations, the situation concerning a home network will be explained first in reference to FIG. 6, and later the situation concerning an office network will be explained in reference to FIG. 7.

FIG. 6 is a signal flow graph in the ring receive mode of a home network where a called party's privacy protection function is set, in accordance with the first exemplary embodiment of the present invention. Referring to FIG. 6, when a calling party makes a call to a desired called party, a call request signal is transmitted from a public network to the system of the present invention (S601). If the system is off hook (S602), a message is sent to the calling party to select a called party (S603).

Upon receiving the message, the calling party inputs information about the desired called party by selecting buttons based on an audio or a DTMF system (S604). If it turns out that the called party has set the location detection rejection mode (S605), the system transmits to the calling party a message conveying that location detection of the desired called party has been rejected (S605). Then, the system transmits a ring signal to other wired and wireless telephone terminals available in the corresponding home network (S606, S607, S608 and S609), and a ring back tone signal to the calling party's telephone (S610).

If the desired called party is found in the second area of FIG. 1 and picks up the receiver of the second wired telephone terminal in the second area to off-hook the telephone (S611), the calling party is able to talk to the called party through the second wired telephone terminal (S612).

The above-described situation can be applied to a home network for connecting a plurality of telephone terminals using the same telephone number.

FIG. 7 is a signal flow graph in the ring receive mode of an office network where a called party's privacy protection function is set, in accordance with the first exemplary embodiment of the present invention. Referring to FIG. 7, when a calling party makes a call to a desired called party, a call request signal is transmitted from a public network to the system of the present invention (S701). If the system is off hook (S702), a message is sent to the calling party to select a called party (S703).

Upon receiving the message, the calling party inputs information about the desired called party by selecting buttons based on an audio or a DTMF system (S704). If it turns out that the called party has set the location detection rejection mode (S705), the system transmits to the calling party a message conveying that location detection of the desired called party has been rejected (S705). Then, the system connects the call to a telephone terminal at a pre-designated location of the called party.

Therefore, if the pre-designated location of the called party is the first wired telephone terminal in the first area, the system transmits a ring signal to the first wired telephone terminal in the first area (S706), whereas a ring back tone signal is transmitted to the calling party's telephone (S707).

If the desired called party is found in the first area and picks up the receiver of the first wired telephone terminal in the first area to off-hook the telephone (S708), the calling party is able to talk to the called party through the first wired telephone terminal (S709).

The above-described situation can be applied to an office network for connecting a plurality of telephone terminals using the same telephone number.

The last situation of the first exemplary embodiment is that call connection fails because a desired called party is absent or on another line. Different from the other situations described above, a location of the called party has already been detected. However, if the desired called party is not in any area where a telephone terminal for receiving the call from a calling party is placed, the system transmits to the calling party a message conveying that the called party is not able to receive the call, and does not attempt to connect the call any further.

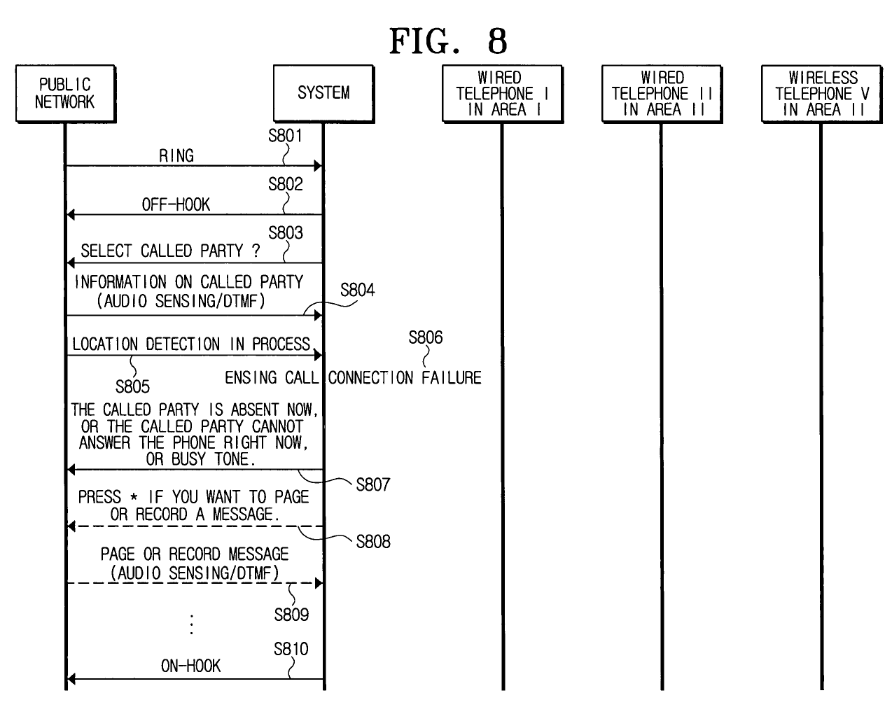

FIG. 8 is a signal flow graph in the ring receive mode where a called party is absent, in accordance with the first exemplary embodiment of the present invention. Referring to FIG. 8, when a calling party makes a call to a desired called party, a call request signal is transmitted from a public network to the system of the present invention (S801). If the system is off hook (S802), a message is sent to the calling party to select a called party (S803).

Upon receiving the message, the calling party inputs information about the desired called party by selecting buttons based on an audio or a DTMF system (S804). Upon receiving information about the called party, the system detects a location of the called party (S805). If it turns out that the called party is in a situation where he cannot receive the call for some reason, for example, he might be in a place where he cannot receive the call at all or he can be on another line (S806), the system transmits to the calling party a message conveying that the called party is not able to receive the call (S807), and does not transmit the call request signal to any of the telephone terminals available for the called party.

Optionally, a message transmission function can be added to the system for the sake of convenience of the calling party and the called party. For instance, before the calling party hangs up the phone, a message requesting the calling party to page the called party or to record a desired message can be transmitted (S808). When the calling party finishes paging or recording the desired message (S809), the system is converted to on hook (S810). In this manner, the called party can check the message(s) provided by the absent subscriber service.

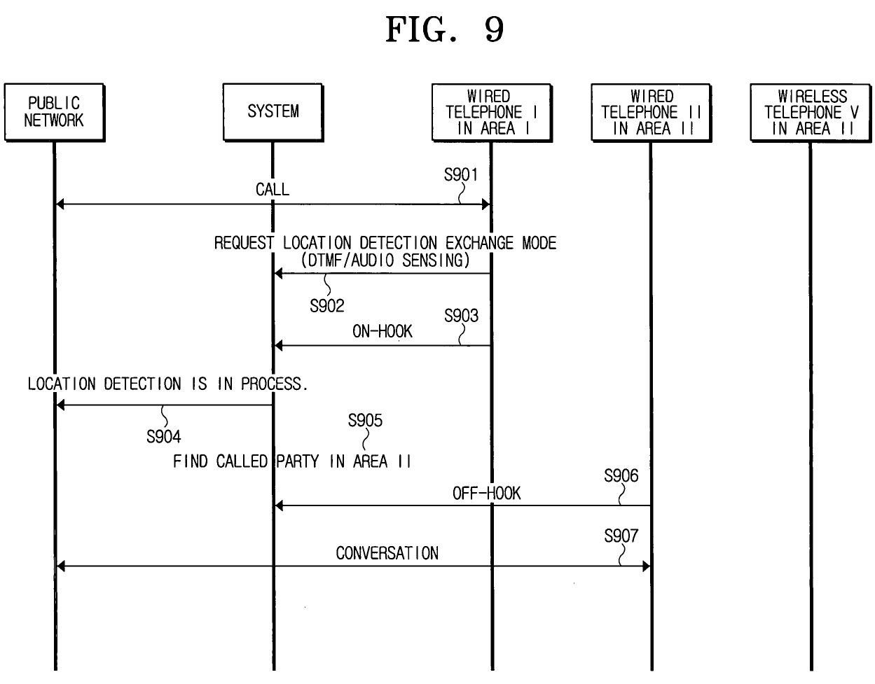

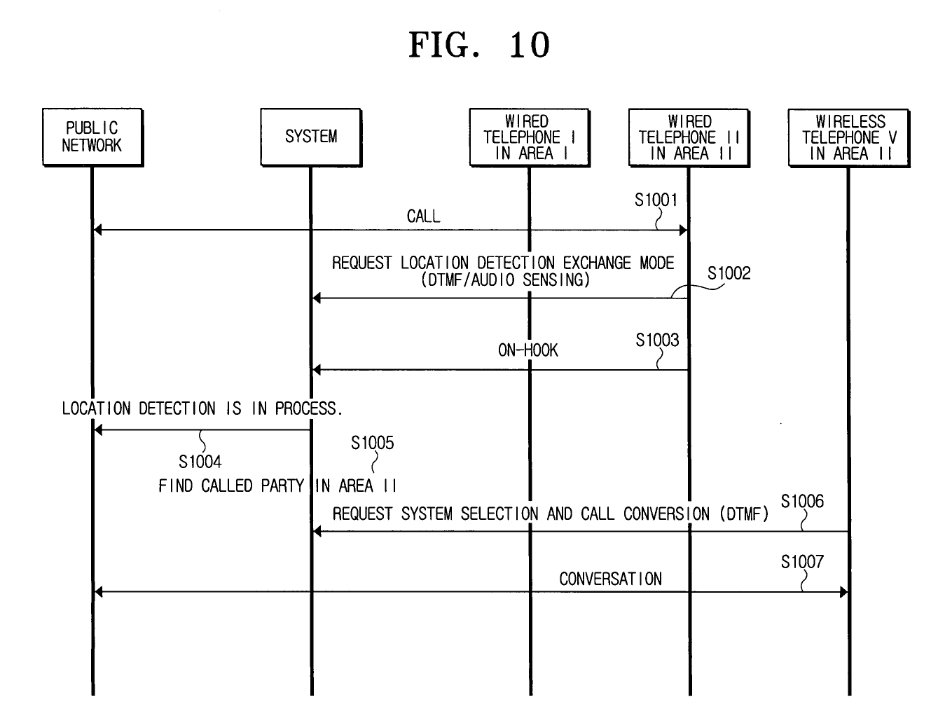

So far, the signal flow procedures in the ring receive mode according to the first exemplary embodiment of the invention have been explained. The following will now explain a signal flow procedure in location detection exchange mode, referring to FIGS. 9 and 10.

### Embodiment 2

Location Detection Exchange Mode

The location detection exchange mode according to the second exemplary embodiment of the present invention concerns a situation where a location of a user currently being on the line is changed. If the user wants to move to another place, he (she) can always set a location detection exchange function even in the middle of conversation. In addition, given that the location detection exchange mode is already set before the user receives a call, the user is able to set an automatic conversion function by locations as he (she) moves to another place. The call conversion to another telephone terminal in the location detection exchange mode can be executed not only between different areas, but also between different telephone terminals (such as, from a wired telephone terminal to a wireless telephone terminal) in a same area or different areas.

First, a call conversion procedure from a wired telephone terminal in one area to a wired telephone terminal in a different area will be explained referring to FIG. 9, and then a call conversion procedure from a wired telephone terminal to a wireless telephone terminal in the same area will be explained referring to FIG. 10.

FIG. 9 is a signal flow graph in the location detection exchange mode of a situation where a user on the line moves to another location, in accordance with the second exemplary embodiment of the present invention. As shown in FIG. 9, suppose that a user (i.e., a calling party) makes a call using the first wired telephone terminal in the first area of FIG. 1 over a public network (S901).

According to the related art, when a user currently on the line wanted to move to another location during a first call, the user had to hang up the telephone and make a second call from a new location using a different telephone of course. However, according to the present invention, the system is capable of tracing variable locations of the user, so that the first call can be automatically converted to anywhere the user goes.

To this end, the user sets the location detection exchange mode to the system through an audio or a DTMF input method (S902), and puts the receiver of the first wired telephone down. Then, the first wired telephone terminal in the first area is converted to on-hook (S903). The system may transmit to the opposite party a message conveying that it is currently detecting a location of the user (i.e., the calling party) (S904), and traces, in real time mode, a new location of the user who has been on the line in the first area.

If the user moves to the second area of FIG. 1, the system detects the location of the user as the second area (S905), and sets a speech path with the second wired telephone terminal in the second area. When the user picks up the receiver of the second wired telephone in the second area, the second wired telephone terminal is converted to off-hook (S906). In this manner, without dialing again, the user can continue the conversation he has been engaged in with the opposite party (S907).

Therefore, according to the second embodiment, when the user moves to a new location while being on the line, he does not have to make a call again because the call is automatically converted to a telephone in the new location.

FIG. 10 is a signal flow graph in the location detection exchange mode of a situation where a user (i.e., a calling party) on the line changes a terminal, in accordance with the second exemplary embodiment of the present invention. As shown in FIG. 10, suppose that a user (i.e., a calling party) makes a call using the second wired telephone terminal in the second area over the public network of FIG. 1 (S1001).

According to the related art, when a user currently on the line wanted to change the second wired telephone to a wireless telephone terminal during a first call, the user had to hang up the telephone, and the user or the user's opposite party had to make another call to the other party to continue the conversation. However, according to the present invention, the system is capable of converting the first call to a different telephone terminal, so that the first call can be automatically converted to anywhere the user goes.

To this end, the user sets the location detection exchange mode to the system through an audio or a DTMF input method (S1002), and puts the receiver of the second wired telephone down. Then, the second wired telephone terminal in the second area is converted to on-hook (S1003). The system may transmit to the opposite party a message conveying that it is currently detecting a location of the user (i.e., the calling party) (S1004), and traces, in real time mode, a new location of the user who has been on the line in the second area.

If the user stays in the second area, the call can be converted to any telephone including the second wired telephone terminal and the fifth wireless telephone terminal in the second area. Suppose that the user requests the system to select the fifth wireless telephone terminal (S1006) and continue the call, the system sets a speech path with the fifth wireless telephone terminal located in the second area. This is made possible because the system of the invention already knows, through its location detection function in real time mode, whether the fifth wireless telephone terminal is available or not. In this manner, without dialing again, the user can continue the conversation he has been engaged in with the opposite party (S1007).

Therefore, according to the second embodiment, when the user currently being on the line wants to change the telephone terminal to another one (i.e., a wireless telephone terminal), he does not have to make a call again because a call is automatically converted from the wired telephone terminal to the wireless telephone terminal.

As explained so far, according to the present invention, when the called party currently being on the line moves to another location, the automatic call conversion system (apparatus) automatically converts the call to a new location even though the telephone number at a new location is not known.

In addition, although the called party is absent, the system (apparatus) of the present invention is capable of detecting a location of the called party in real time mode, so the forwarded line does not ring. Instead, an incoming call is automatically forwarded to a telephone near the called party wherever he (she) goes, allowing the called party to be able to answer his (her) call more effectively.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An automatic call conversion system, comprising:
a sensor network which traces a location of a telephone user in real time mode, and transmits location information corresponding to the location of the telephone user;
a plurality of telephone terminals comprising at least one of wired and wireless telephones, each having a call forwarding function for the telephone user; and
an automatic call conversion apparatus which receives the location information of the telephone user from the sensor network, selects among the plurality of telephone terminals a telephone terminal for use in call receiving or call conversion by using the location information, and sets a speech path with the selected telephone terminal or converts a call to the selected telephone terminal.

2. The system according to claim 1, wherein the sensor network comprises:
a plurality of sensor nodes which detects the location information of the telephone user in real time mode, and provides the location information to the automatic call conversion apparatus; and
a sensor platform which provides the location information from each of the sensor nodes to the automatic call conversion apparatus.

3. The system according to claim 1, wherein the sensor network senses the location information of the telephone user by a radio frequency tag (RF TAG).

4. The system according to claim 1, wherein the automatic call conversion apparatus comprises:
a location detection part which receives and detects the location information of the telephone user provided from the sensor network; and
a location detection switch control part which receives the location information of the telephone user from the location detection part, and selects, based on the received location information, the telephone terminal for use in the call receiving or the call conversion for the telephone user.

5. The system according to claim 4, wherein the automatic call conversion apparatus further comprises:
a switch part which receives information on the selected telephone terminal from the location detection switch control part, and switches the call to the selected telephone terminal according to the received information.

6. The system according to claim 4, wherein the automatic call conversion system further comprises:
a central processing unit (CPU) part which performs operations and processes of each functional component in the automatic call conversion apparatus;
a memory part which stores data necessary for the automatic call conversion apparatus;
a public network interface part which interfaces the automatic call conversion apparatus with a public network; and
a tone generation and tone detection and dial pulse detection part which generates a dial tone to be transmitted to a called party or a calling party while dialing, or performs tone detection and dial pulse detection.

7. The system according to claim 4, wherein the automatic call conversion apparatus further comprises:
an audio processing part which senses and synthesizes audio information on the telephone user, or audio information requesting to detect the location information of the telephone user.

8. An automatic call conversion apparatus, comprising:
a location detection part which receives and detects location information of a telephone user, the location information of the telephone user being traced in real time mode; and
a location detection switch control part which receives the location information of a telephone user from the location detection part, and selects, based on the received location information, a telephone terminal for use in call connection or call conversion for the telephone user.

9. The apparatus according to claim 8, wherein the location information of the telephone user is sensed by a radio frequency tag (RF TAG).

10. The apparatus according to claim 8, further comprising:
a switch part which receives information on the selected telephone terminal from the location detection switch control part, and switches the call to the selected telephone terminal according to the received information.

11. The apparatus according to claim 8, further comprising:
a central processing unit (CPU) part which performs operations and processes of each functional component in the apparatus;
a memory part which stores data necessary for the apparatus;
a public network interface part which interfaces the apparatus with a public network; and
a tone generation and tone detection and dial pulse detection part which generates a dial tone to be transmitted to a called party or a calling party while dialing, or performs tone detection and dial pulse detection.

12. The apparatus according to claim 8, further comprising:
an audio processing part which senses and synthesizes audio information on the telephone user, or audio information requesting to detect the location information of the telephone user.

13. An automatic call conversion method comprising:
a calling party's making a call to a called party and transmitting a call request signal;
the calling party's receiving a message requesting to select the called party and inputting information on the called party;
based on the inputted information on the called party, detecting a location of the called party;
based on the location information of the called party, selecting a telephone terminal for use in call receiving among a plurality of telephone terminals comprising at least one of wired and wireless telephones, each having a call forwarding function for the called party; and
setting a speech path between a terminal of the calling party and the selected terminal.

14. The method according to claim 13, wherein the information on the called party is inputted by an audio input.

15. The method according to claim 13, wherein the information on the called party is inputted by a dual tone multi-frequency (DTMF) input.

16. The method according to claim 13, wherein the location information of the called party is sensed by a radio frequency tag (RF TAG).

17. The method according to claim 13, further comprising:
if the called party requests to reject detecting the location of the called party, transmitting to the calling party a message conveying that detecting the location of the called party is rejected; and
transmitting a ring signal to every telephone terminal available in a network corresponding to the called party.

18. The method according to claim 13, further comprising:
if the called party requests to reject detecting the location of the called party, transmitting to the calling party a message conveying that detecting the location of the called party is rejected; and
connecting a call to a telephone terminal at a pre-designated location of the called party in a network corresponding to the called party.

19. The method according to claim 13, further comprising:
if the called party is in a situation where receiving the call is not possible, transmitting to the calling party a message conveying that the called party is not able to receive the call; and
terminating call connection to the called party.

20. The method according to claim 19, wherein the situation where the called party is not able to receive the call, comprises at least one of a situation where the called party is not found, a situation where the called party requests to reject detecting a location of the called party, and a situation where the called party is on another line.

21. The method according to claim 19 further comprises, wherein, after the transmitting to the calling party a message conveying that the called party is not able to receive the call, the method further comprises:
transmitting to the calling party a message requesting the calling party to record a paging message or a desired message; and
the calling party's finishing recording the paging message or the desired message and transmitting the recorded message.

22. An automatic call conversion method, comprising:
a telephone user's making a call to an opposite party or receiving a call from the opposite party with a first telephone terminal through a public network, wherein the telephone user and the first telephone terminal are located in a first area;
the telephone user's requesting to detect a location of the telephone user and converting the first telephone terminal to on-hook;
tracing, in real time mode, a location of the telephone user engaged in the call in the first area;
if the telephone user moves from the first area to a second area, setting a speech path with a second telephone terminal located in the second area; and
if the telephone user picks up a receiver of the second telephone terminal in the second area, resuming the call with the opposite party.

23. The method according to claim 22, wherein requesting to detect the location of the telephone user is performed by an audio input.

24. The method according to claim 22, wherein requesting to detect the location of the telephone user is performed by a dual tone multi-frequency (DTMF) input.

25. The method according to claim 22, wherein, after the first telephone terminal is converted to on-hook, the method further comprises:
transmitting to the opposite party a message conveying that detecting the location of the telephone user is in process.

26. The method according to claim 22, wherein each of the first and the second telephone terminals is one of a wired and wireless telephones.

27. An automatic call conversion method, comprising:
a telephone user's making a call to an opposite party or receiving a call from the opposite party with a first telephone terminal through a public network, wherein the telephone user and the first telephone terminal are located in a first area;
the telephone user's requesting to detect a location of the telephone user and converting the first telephone terminal to on-hook;
tracing a location of the telephone user engaged in real time mode;
the telephone user's requesting to convert the call to a second telephone terminal located in the first area; and
the telephone user's resuming the call to the opposite party with the second telephone terminal.

28. The method according to claim 27, wherein requesting to detect the location of the telephone user is performed by an audio input.

29. The method according to claim 27, wherein requesting to detect the location of the telephone user is performed by a dual tone multi-frequency (DTMF) input.

30. The method according to claim 27, wherein, after the telephone terminal is converted to on-hook, the method further comprises:
transmitting to the opposite party a message conveying that detecting the location of the telephone user is in process.

31. The method according to claim 27, wherein each of the first and the second telephone terminals is one of wired and wireless telephones.
